(19) United States
(12) Patent Application Publication
(10) Pub. No.: US 2017/0257934 A1
(43) Pub. Date: Sep. 7, 2017

(54) WIRELESS SIGNAL LIGHT SYSTEMS FOR VEHICLES INCLUDING WIRELESS ILLUMINATED GEAR AND CLOTHING

(71) Applicant: Brian Jon Garvey, SAN DIEGO, CA (US)

(72) Inventor: Brian Jon Garvey, SAN DIEGO, CA (US)

(21) Appl. No.: 15/451,309

(22) Filed: Mar. 6, 2017

Related U.S. Application Data
(60) Provisional application No. 62/304,167, filed on Mar. 5, 2016.

(51) Int. Cl. H05B 37/02; B62J 6/00; F21V 33/00; B60Q 9/00; B60Q 1/00; B62J 6/04; A63C 17/26

(52) U.S. Cl. CPC H05B 37/0272; B62J 6/04; B62J 6/005; A63C 17/26; B60Q 9/00; B60Q 1/00; F21V 33/0008; B62J 2006/008; B60Q 1/22

(57) ABSTRACT

Wireless signal light systems for vehicles, including wireless illuminated gear and clothing, are provided. In an example system, a wireless transmitter is communicatively coupled to a motorcycle or other vehicle. Receivers in illuminated articles, such as helmet, backpack, jacket, vest, race suit, gloves, boots, and other gear receive signaling information from the transmitter, such as left and right turn signaling and braking of the motorcycle or vehicle. Colored LEDs or other lighting in the illuminated articles mirror the signaling of the motorcycle or vehicle. Left and right gloves and boots may have respective left and right LED turn signal indicators. A pushbutton on each illuminated article synchs the article with the signaling system of the vehicle. The illuminated articles and can sense an emergency through position or by separation from the vehicle and activate emergency flashers, sound, and emergency contacts through a phone. The system batteries also have hazard protection.

### RELATED APPLICATIONS

This patent application claims the benefit of priority to U.S. Provisional Patent Application No. 62/304,167 to Garvey, entitled, “Wireless Illuminated Gear,” filed Mar. 5, 2016, and incorporated herein by reference in its entirety.

### BACKGROUND

Vehicles that are used in many modes of transportation, and devices used in sports, may have indicator lights to signal their presence, braking, slowing, turning, emergencies, and so forth. Safety is often addressed with the signal lighting. For example, most motor vehicles since 1986 are required to have a “center high mount stop lamp (CHMSL),” a brake light that is located 48 inches above grade for better visibility. No such requirement has been made for motorcycles or motorcycle riders, however. In 2013, for example, there were over 120,000 motorcycle fatalities in the U.S. and 73% of these accidents occur at night, when human motorcycle riders disappear from visibility of the other drivers. Further, motorcycle riders are not attached to the motorcycles equipped with the signal lights, so when the riders become separated from their motorcycles, the riders are difficult to see, and also hard to find after an accident.

### SUMMARY

Wireless signal light systems for vehicles, including wireless illuminated gear and clothing, are provided. In an example system, a wireless transmitter is communicatively coupled to a motorcycle or other vehicle. Receivers in illuminated articles, such as helmet, backpack, jacket, vest, race suit, gloves, boots, and other gear receive signaling information from the transmitter, such as left and right turn signaling and braking of the motorcycle or vehicle. Colored LEDs or other lighting in the illuminated articles mirror the signaling of the motorcycle or vehicle. Left and right gloves and boots may have respective left and right LED turn signal indicators. A pushbutton on each illuminated article synchs the article with the signaling system of the vehicle. The illuminated articles and can sense an emergency through position or by separation from the vehicle and activate emergency flashers, sound, and emergency contacts through a phone. The system batteries also have hazard protection.

This summary is not intended to identify key or essential features of the claimed subject matter, nor is it intended to be used as an aid in limiting the scope of the claimed subject matter.

### BRIEF DESCRIPTION OF THE DRAWINGS

Embodiments of the disclosure will be described with reference to the accompanying drawings, wherein like reference numerals denote like elements. The accompanying figures illustrate the various implementations described herein and are not meant to limit the scope of the various technologies described.

FIG. 1 is a diagram of a circuit layout of an example transmitter unit of the example wireless light signal system.

FIG. 2 is a diagram of a circuit layout of an example receiver unit of the example wireless light signal system.

FIG. 3 is a screenshot of an example phone application of the example wireless light signal system.

FIG. 4 is a diagram of an example transmitter unit of the wireless light signal system attached to a motorcycle.

FIG. 5 is a diagram of an example battery pack of the example wireless light signal system.

FIG. 6 is perspective view diagrams of an example illuminated helmet article of the example wireless light signal system.

FIG. 7 is perspective view diagrams of an example illuminated backpack article of the example wireless light signal system.

FIG. 8 is perspective view diagrams of an example illuminated jacket article of the example wireless light signal system.

FIG. 9 is perspective view diagrams of an example illuminated race suit article of the example wireless light signal system.

FIG. 10 is a diagram of an example illuminated glove article of the example wireless light signal system.

FIG. 11 is a diagram of an example illuminated boot article of the example wireless light signal system.

FIG. 12 is a diagram of an example battery and wireless receiver combination pack of the example wireless light signal system.

FIG. 13 is a diagram of the combination pack of FIG. 12 installed on a trailer arm to mirror the signal lighting patterns of the vehicle towing the trailer.

FIG. 14 is a flow diagram of an example method of automotive signaling from an article worn by a human operator of a vehicle.

### DETAILED DESCRIPTION

This disclosure describes wireless signal light systems for vehicles including wireless illuminated gear and clothing. For example, an illuminated motorcycle helmet may have lights wirelessly controlled to flash brake light indicators, turn signal light indicators, blinkers, running lights, emergency flashers, and so forth located on the helmet. The lighting elements may be light emitting diodes (LEDs), or other lights. Likewise, illuminated articles such as backpacks, race suits, jackets, vests, boots, shoes, gloves, clothing, and devices such as trailers, may each have lights wirelessly controlled to show illuminated brake, turn signal, blinkers, running lights, emergency flashers, and other indictors on the given article, gear, or device.

Illuminated motorcycle gear, clothing, and accessories are used as examples for the sake of description, but the subject matter may apply to numerous moving vehicles and devices, and to the gear and articles associated with these vehicles and devices, such as motorcycles, mopeds, scooters, skateboards, ATVs, bicycles, roller skates, hover boards, jetpacks, watercraft, automobiles, personal and group transportation, and so forth. The subject matter may also be utilized by emergency vehicles, fire engines, firefighters and their gear, air traffic ground control (tarmac), traffic & parking control (police and others), pedestrians, runners, hikers, skiers, snowboarders, boaters, para-jumpers, police officers, forest fire crews, paramedics, pets, and so forth.

In an example implementation, an example wireless signal light system incorporates motorcycle gear so that a motorcycle and its rider (and its passengers) can be seen at night, and also during the day, from all sides: front, back, right and left sides: so that the operator's intent for braking, stopping, turning, or changing lanes, can be seen on different articles, such as a helmet, backpack, or jacket, and visible 48 inches above grade, for example, making it easier for other motorists and pedestrians to see a motorcyclist's current and future path and driving intentions.

In an example scenario, a motorcycle is equipped with a transmitter of the example wireless signal light system. When the transmitter is turned on, the lights in or on the outfitted gear are all turned on automatically, via a small rechargeable battery. A PCB (protection circuit board) module may be installed to protect the battery from damage, and to protect the human rider from potential harm from certain types of battery events, such as exploding or overheating due to overcharging. The PCB capability also protects the equipment from misbehavior of the battery pack.

An example wireless transmitter and wireless receiver of the example system may be latest state-of-the-art instances and these components may utilize the latest forward error correction (FEC) decoding. The radio frequency (RF) scheme of the example wireless transmitter and receiver combinations may use Bluetooth, Wi-Fi, or other wireless communication technologies, and may have a 1000 meter or more working range between the transmitter unit located on the motorcycle, vehicle, or device, and each receiver unit located in each illuminated article or piece of gear that has an automotive signal light incorporated. The wireless signal light system may also incorporate fiber optics in the illuminated articles or on the vehicle or device.

In an implementation, if the motorcycle rider, driver, or other operator of a base vehicle carrying the wireless transmitter becomes separated from their motorcycle or base vehicle, the lights on the article, gear, or equipment bearing the wireless receiver will remain on, up to at least a 1000 meter separation. For example, the lights on the gear remain on, for example in a flashing mode, in a crash or when the rider is just walking around their motorcycle, on the roadway. In an implementation, if the wireless receiver unit located in the gear is separated from the wireless transmitter unit on the motorcycle or base vehicle by a selected distance, for example by 10 feet or more, or if the motorcycle or base vehicle is rotated a certain amount, for example by 60 degree or more for a selected period, for example 10 seconds, then an “emergency flash mode” (EFM) in the wireless receiver may be triggered, and all the signal lights, such as LEDs, on all gear bearing a wireless receiver may begin to flash or may be continuously illuminated, alternating from half-bright to full-bright, to make the rider(s) more visible to other oncoming motorists, and to make the location of a fallen or disabled rider easier to find, when every second counts in an emergency.

An application for smart phones or other mobile devices may have a user interface for entering the parameters for the emergency flash mode (EFM), such as distance of separation between gear and base vehicle before the EFM is triggered, degree of rotation of vehicle with respect to rider, and time interval combination before EFM is triggered, and so forth. The amount of LED brightness and flash characteristics may also be selected or programmed, such as LED logo colors, LED flash modes, and flash speeds and durations.

A gyroscope, accelerometer, and/or other sensors may also be included in the wireless transmitter or a wireless receiver of the example system to activate the emergency flash mode (EFM) or to determine or help determine signaling characteristics or emergency flash mode EFM characteristics. An audio speaker may be included in an illuminated article or gear to be activated in an emergency with a loud alarm signal so that the rider(s) can be found faster and more easily.

The wireless transmitter, keyed to one or more respective receivers of the same owner or the same base vehicle, can be located in numerous allowed locations on the motorcycle or base vehicle, and connected to the existing wiring using an easy-to-install one line diagram that references the wiring diagrams of most motorcycles, for example.

The transmitter portion of the example wireless signal light system may also be implemented in newly manufactured motorcycles or base vehicles, able to communicate automotive signaling, such as braking and turn signals to numerous different illuminated articles, each bearing a wireless receiver. A rider can wear multiple different pieces of gear while connecting to just one wireless transmitter unit on the motorcycle or base vehicle. Likewise, the illuminated articles and gear can easily be connected to a different motorcycle or base vehicle that is equipped with a separate or a different wireless transmitter unit. In an implementation, each wireless receiver has a small, ‘SYNCH’ pushbutton, which when pressed within 10 seconds of the motorcycle or base vehicle being turned on, connects that illuminated article, gear, or other equipment with the wireless transmitter unit and native signal lighting system on that motorcycle or base vehicle, making it easy to connect multiple pieces of equipment for easy pairing with other motorcycles of base vehicles.

In an implementation, the wireless transmitter unit may have 281,474,976,710,656 available addresses, for example, that can automatically connect to a given receiver unit of an illuminated article, so that no two or more motorcycles, for example, can affect each other's wireless gear and equipment. The example phone or mobile device application allows the user to adjust functions of the LEDs on all of the equipment, such as custom logos on LED lenses, intensities, colors of LEDs, strobe and flash effects, and Emergency Flash Mode (EFM) options. The example phone application can also allow calling, texting, emailing, and the like, including automatic notification of emergency contacts via the rider's cell phone if an illuminated backpack or other illuminated equipment activates the EFM of the wireless transmitter unit.

The example phone application can also coordinate a GPS location of a given wireless receiver located in an illuminated piece of the gear or clothing when the EFM has been triggered, for example via a location service from the user's phone, wearable gear, or smart watch, in order to make the emergency notification of contacts. The example mobile phone application can also be used as a standalone emergency notification system, for runners, hikers, skiers, firefighters, police officers, bicyclists, and others who want emergency notifications to be made if they have been in an accident and may need assistance.

In an implementation, the example wireless transmitter of the system can also be installed on an automobile or truck so that if a trailer (such as a semi, boat trailer, RV, etc.) or other device needs to reflect the automobile or truck's signaling lights, brake lights, and turn signals, the trailer or other device being towed may be equipped with an instance of the wireless receiver, connecting to the wireless transmitter unit without wires or need for wire harness, via Bluetooth, Wi-Fi, or other wireless communication.

In an implementation, an automobile may be equipped with an embodiment of the example wireless receiver to sense when motorcycles are near, the wireless receiver informing a GPS display, alarm, or dashboard indicator of the automobile, in one implementation.

The wireless transmitter and/or wireless receivers of the system can also be voice activated or controlled by the example mobile phone application, which can work with a mobile phone's gyroscope and/or accelerometer to detect a rider's movement or position.

In an implementation, the illuminated articles, gear, devices, and clothing turn of all lights (e.g., LEDs) when the motorcycle or base vehicle is turned off.

In an implementation, yellow LEDs may be used for accessory lights, turn signal lights, and emergency flashers, for example, and red LEDs for tail lights, brake lights, and so forth. The signal lights may be located on the front and back of example illuminated articles, for 360 degree visibility. The light sources used may be waterproof and shock proof. Lights may also be 3 volt sources using no diodes for less heat and longer life, allowing smaller, lighter battery sources.

In an implementation, an example battery pack has 3.7 volt batteries (not 10-14 volt batteries) or batteries with even lower voltage, and rechargeable via Universal Serial Bus (USB), solar, or other means of charging. As introduced above, the batteries may be accompanied by a PCB module to protect the user from explosions and other hazards that may occur from over and/or undercharging of the power source.

Example Systems

FIG. 1 shows an example wireless transmitter 100 of the example wireless signal light system. The example wireless transmitter 100 may utilize Bluetooth, Wi-Fi, or other wireless communication technology. In an implementation, the example wireless transmitter 100 includes an Emergency Flash Mode (EFM) a siren/alarm, a signal generator 102, a wireless communications chip 104, a gyroscope/accelerometer chip 106, an antenna 108, an automatic address generator 110, a mobile phone application interface module 112, and an Emergency Flash Mode (EFM) generator 114.

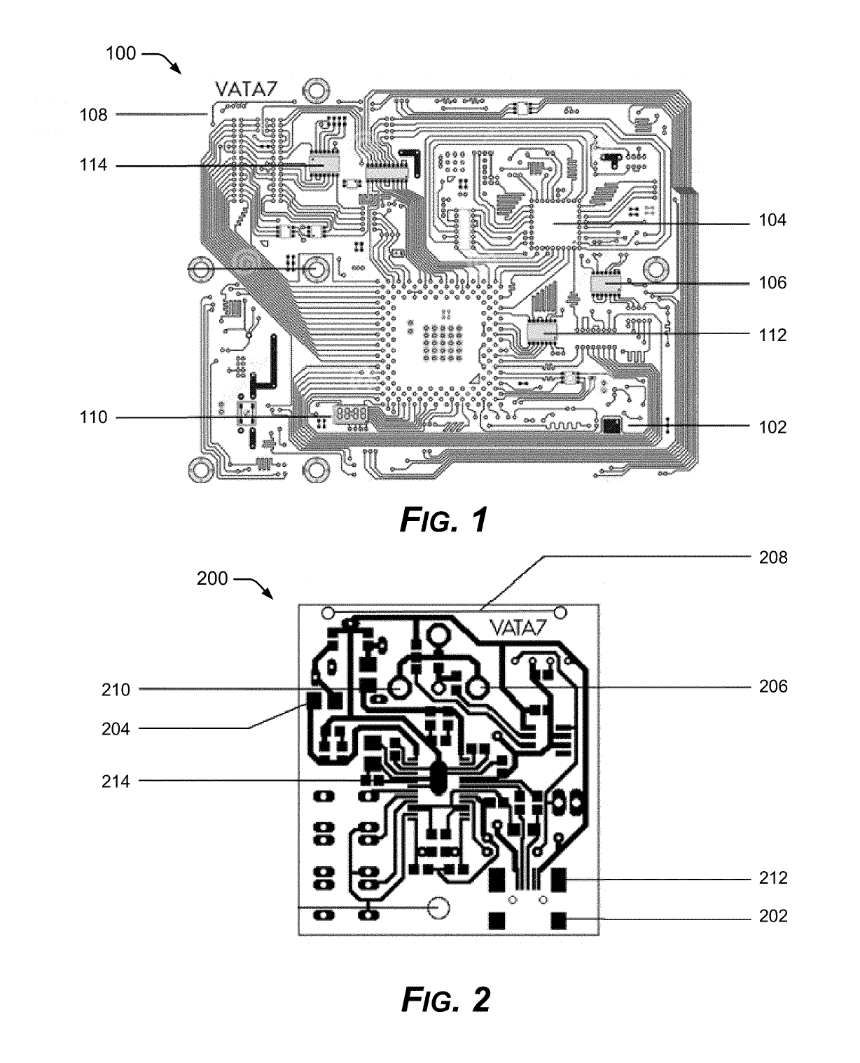

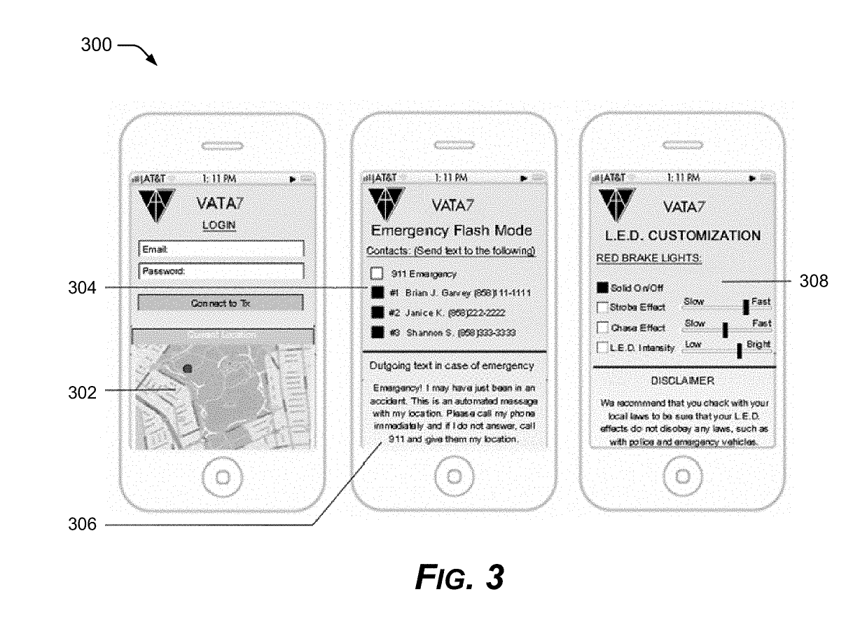

FIG. 2 shows an example circuit board of the wireless receiver 200 of the example wireless signal light system. The example wireless receiver 200 may have an Emergency Flash Mode (EFM) siren/alarm, a signal generator 202, a wireless communications chip 204, a gyroscope/accelerometer chip 206, an antenna 208, a mobile phone application interface module 210, an Emergency Flash Mode (EFM) generator 212, and a synch (Pairing) button/switch 214.

FIG. 3 shows an example user interface 300 of an example mobile phone application displaying a GPS location services map 302. The example mobile phone application may have an ability to access the phone's contact list or address book to allow selection of emergency contacts 304. A standard emergency text or email (can be customized/edited) can be automatically sent to the contacts selected when the Emergency Flash Mode (EFM) has been activated 306. The example mobile phone application may also allow customization control 308 of the LED signal lights, for example, on illuminated articles and gear.

FIG. 4 shows a vehicle 400 with the example wireless transmitter 100 mounted in one of many possible locations. The example wireless transmitter 100 can be mounted in numerous places on a motorcycle, moped, scooter, skateboard, car, semi-truck, vehicle, or other personal transportation device.

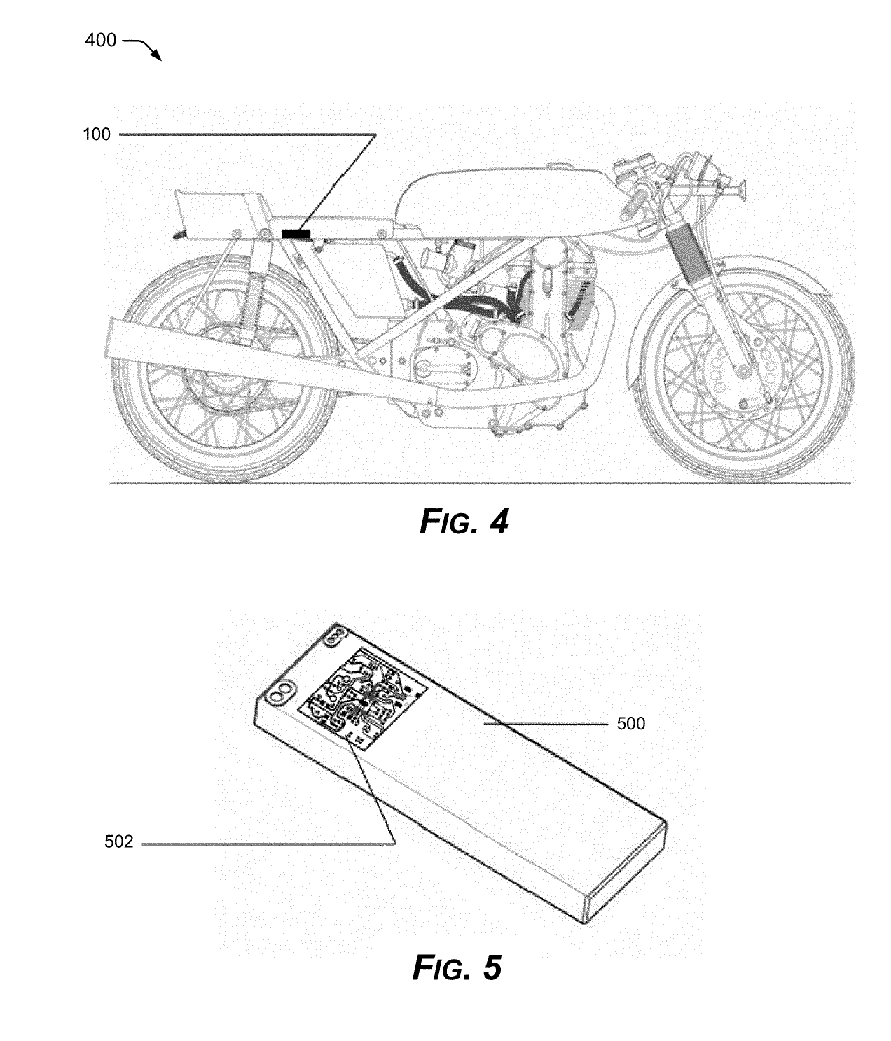

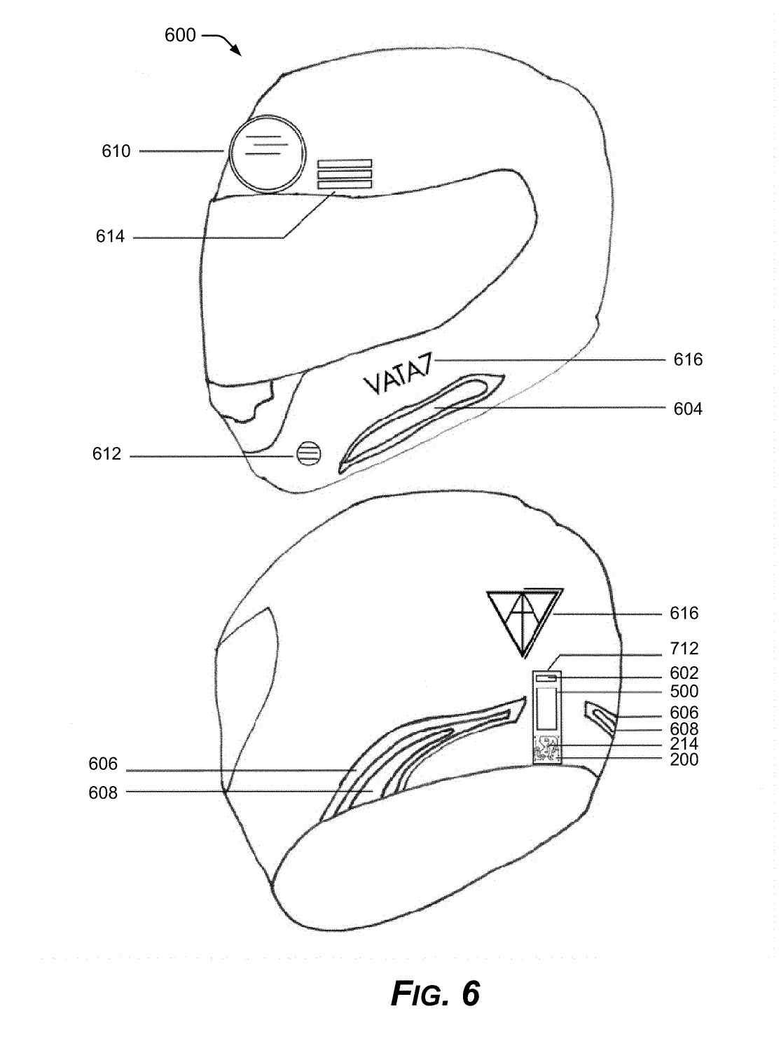

FIG. 5 shows an example rechargeable, low voltage (3.7 volts or less) battery, which has a PCB module 502 for protection, keeping the battery and human rider from hazards, such as exploding, due to under or over charging, for example.

FIG. 6 shows an example illuminated article 600, for example a motorcycle helmet, with perspective views of front and back. The example wireless receiver 200 has a ‘synch’ button 214 and rechargeable battery 500 in a water tight enclosure with a USB plug-outlet 602 for charging. The illuminated motorcycle helmet has recessed and semi-recessed, or surface-mounted, waterproof lenses with LEDs, such as yellow accessory lights and turn signals on the front 604 and back 606, and red LED taillights and brake lights 608 on the back, with a headlamp 610 on the front. The helmet may also have a microphone 612 for voice commands and speaker for EFM alarm sounds. There may also be vents 614 to bring air from the front of the helmet to the battery compartment for cooling. The illuminated article 600 may have a logo or other identifier 616 to demonstrate that the illuminated article 600 is part of the wireless signal light system and compatible with a complementary wireless transmitter 100 of a given vehicle.

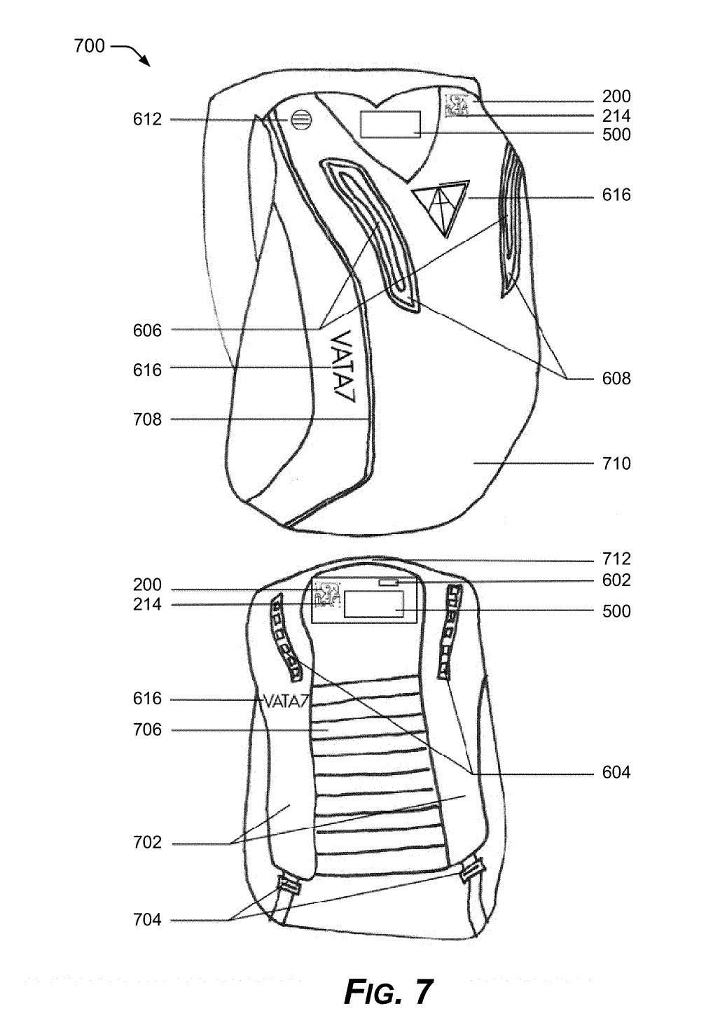

FIG. 7 shows an example illuminated article 700, a wireless illuminated backpack with perspective views of the front and back. The wireless illuminated backpack has an instance of the example wireless receiver 200 with a ‘synch’ button 214 and rechargeable battery 500 in a water tight enclosure and a USB plug-outlet 602 for charging. Also shown are recessed, semi-recessed, or surface-mounted water proof lenses with LEDs, yellow accessory lights/turn signal LEDs 604 & 606 on the front shoulder straps (604), and back shell (606), and red taillights/brake lights 608 on the back shell, with padded shoulder straps 702, quick release fasteners 704, and padded, ribbed backing 706 for cool, comfort. The wireless illuminated backpack 700 may have a microphone 612 and speaker, for voice commands and EFM alarm sound respectively, and reflective piping 708 for high visibility. The illuminated article 700 may have logos or other identifiers 616 to demonstrate that the illuminated article 700 is part of the wireless signal light system and compatible with a complementary wireless transmitter 100 of a given vehicle.

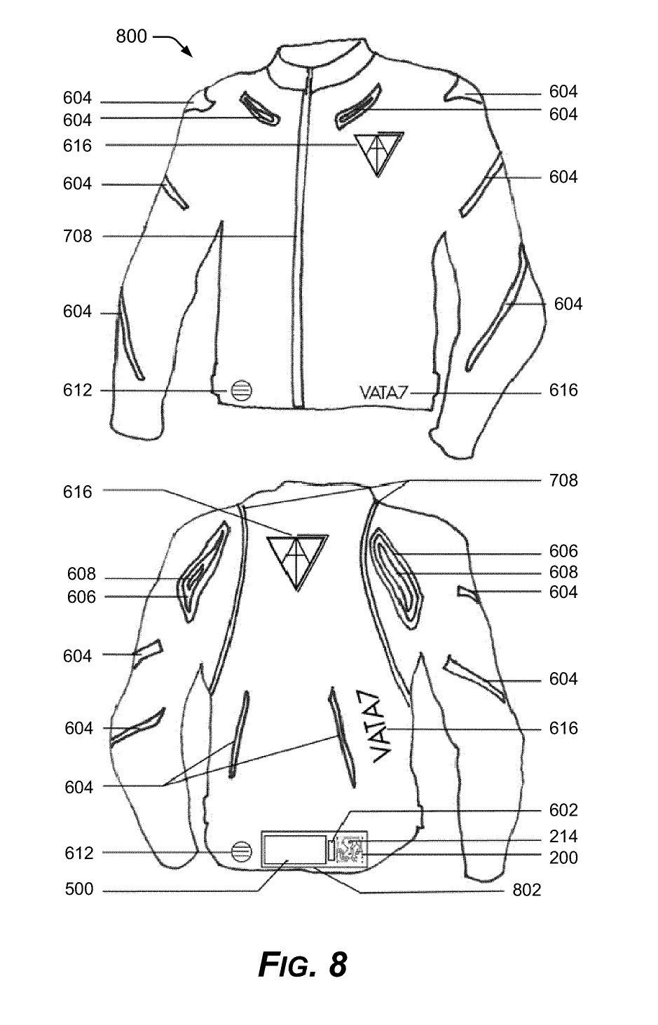

FIG. 8 shows an example illuminated article 800 of the wireless signal light system, an example illuminated jacket 800 with front and back views. The example illuminated jacket 800 has a wireless receiver unit 200 with a ‘synch’ button 214 and rechargeable battery 500 in a water tight enclosure, with a USB plug-outlet for charging 602. A pouch 802 in the jacket 800 may hold the wireless receiver unit 200. The example illuminated jacket 800 also has recessed, semi-recessed, or surface mounted waterproof lenses with LED lights, for example front yellow LED accessory lights/turn signals 604 on the front, and back yellow LED accessory lights/turn signals 606 on the back. The example illuminated jacket 800 has red tail lights/brake lights 608 on the back, and a microphone 612 for voice commands and speaker for EFM alarm sounds, and illuminated or at least reflective piping 708, and logos 616.

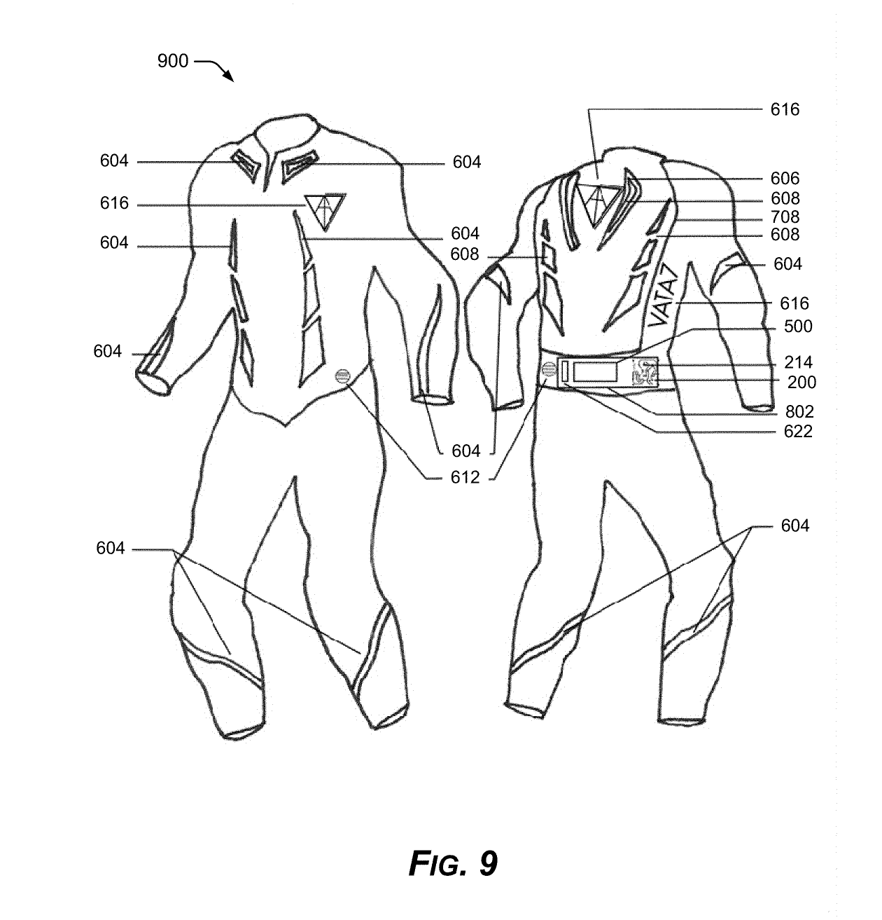

FIG. 9 shows an example illuminated article 900 of the wireless signal light system, an example illuminated race suit 900, with front and back views. The example illuminated race suit 900 has a wireless receiver unit 200 with a ‘synch’ button 214 and rechargeable battery 500 in a water tight enclosure, with a USB plug-outlet for charging 602. A pouch 802 in the race suit 900 may hold the wireless receiver unit 200. The example illuminated race suit 900 also has recessed, semi-recessed, or surface mounted waterproof lenses with LED lights, for example front yellow LED accessory lights/turn signals 604 on the front, and back yellow LED accessory lights/turn signals 606 on the back. The example illuminated race suit 900 has red tail lights/brake lights 608 on the back, and a microphone 612 for voice commands and speaker for EFM alarm sounds, and reflective or illuminated piping 708, and logos 616.

FIG. 10 shows an example illuminated article 1000 of the wireless signal light system, example illuminated gloves(s) 1000. An example illuminated glove 1000 has a wireless receiver unit 200 with a ‘synch’ button 214 and rechargeable battery 500 in a water tight enclosure, with a USB plug-outlet for charging 602. A pouch 802 in the glove 1000 may hold the wireless receiver unit 200. The example illuminated glove 1000 also has recessed, semi-recessed, or surface mounted waterproof lenses with LED lights, for example front yellow LED accessory lights/turn signals 604 on the side or outside of the glove 1000. The example illuminated glove 1000 may have a microphone 612 for voice commands and speaker for EFM alarm sounds.

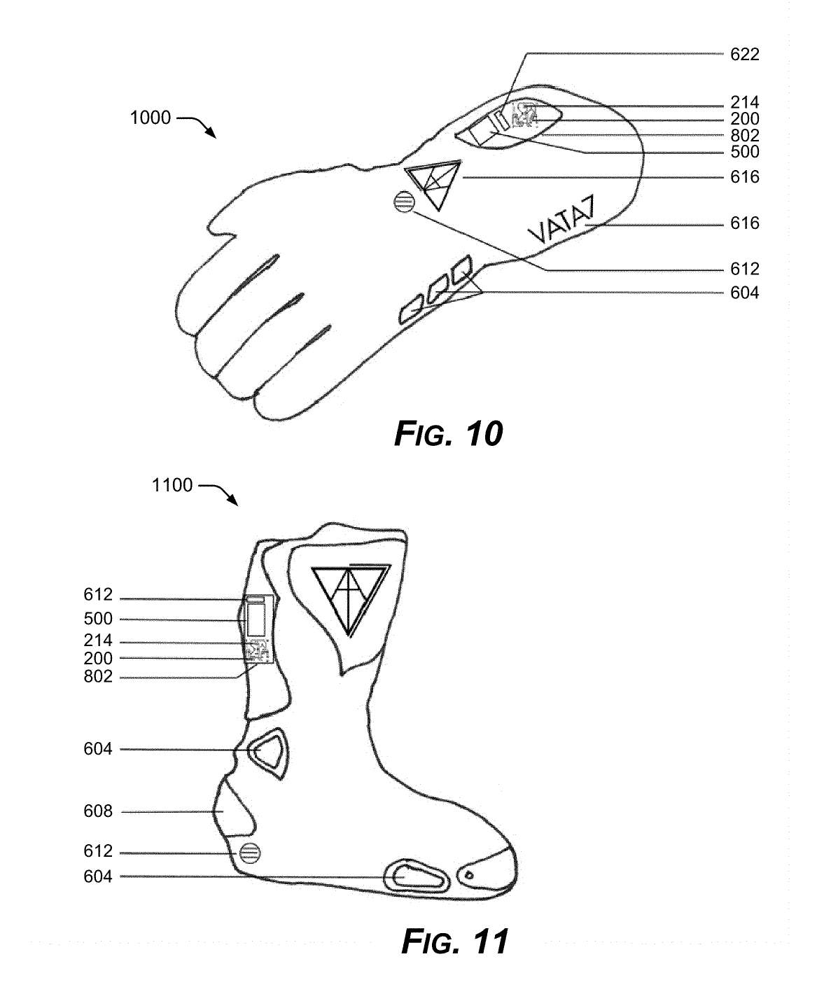

FIG. 11 shows an example illuminated article 1100 of the wireless signal light system, an example illuminated boot(s) 1100. An example illuminated boot 1100 has a wireless receiver unit 200 with a ‘synch’ button 214 and rechargeable battery 500 in a water tight enclosure, with a USB plug-outlet for charging 602. A pouch 802 in the boot 1100 may hold the wireless receiver unit 200. The example illuminated boot 1100 also has recessed, semi-recessed, or surface mounted waterproof lenses with LED lights, for example front yellow LED accessory lights/turn signals 604 on the side or outside of the boot 1100. The example illuminated boot 1100 has red tail lights/brake lights 608 on the back heel. The example illuminated boot 1100 may have a speaker 612 for EFM alarm sounds, and logos 616.

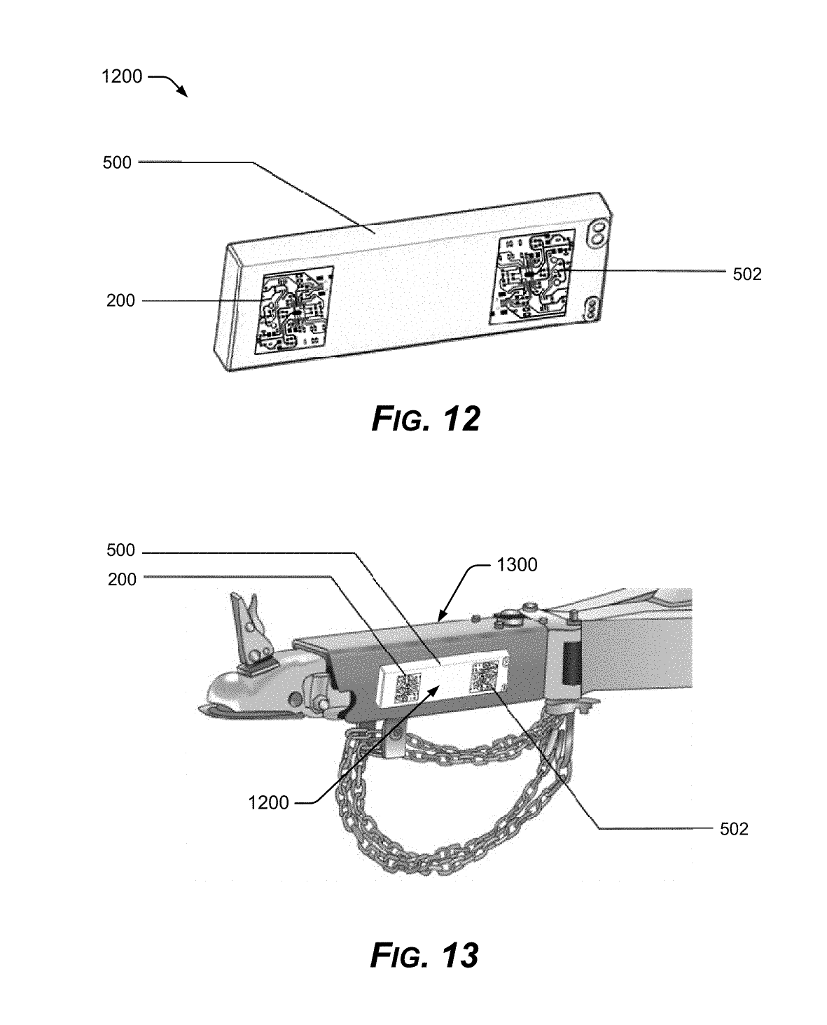

FIG. 12 shows an example battery and wireless receiver combination pack 1200. The combination pack 1200 has a rechargeable, low voltage (3.7 volts or less) battery 500, which may have a PCB module 502 for battery protection, to keeping the battery from hazards such as exploding and short longevity due to under or over charging. The combination pack 1200 has an instance of the example wireless receiver 200. The example combination pack 1200 may be installed for propagating turn lights and brake lights to trailers, without need for wires or a wire harness.

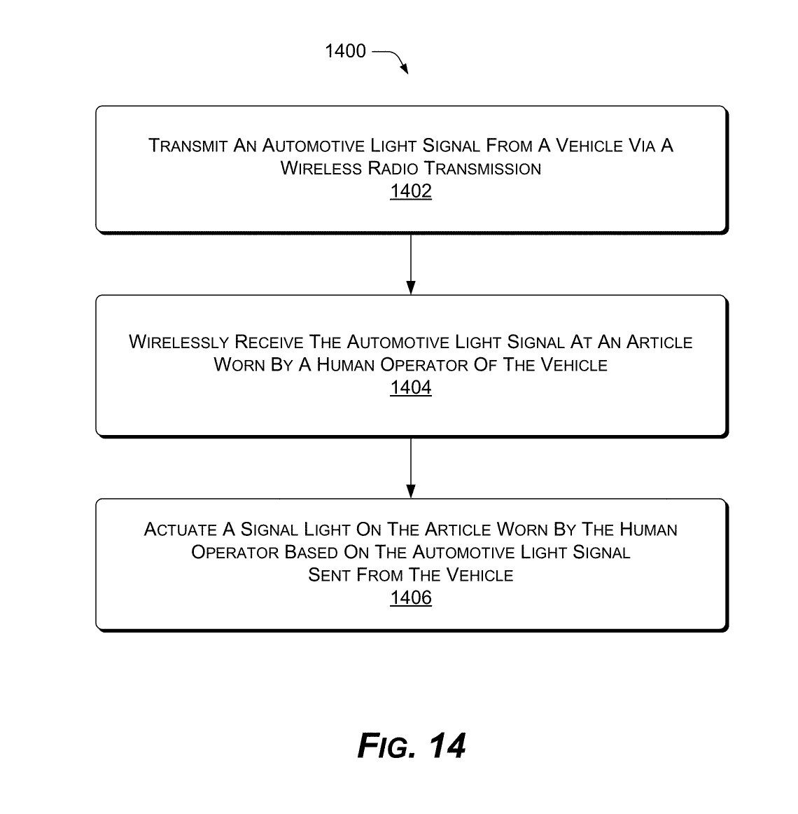

FIG. 13 shows the combination pack of FIG. 12 installed on a trailer arm 1300 to mirror the signal lighting patterns of the vehicle towing the trailer. The example combination pack 1200 may be installed or placed on or near a trailer hitch, or on the trailer itself, such as the trailer arm 1300. The combination pack 1200 may also be used for emergency vehicles and devices, by firefighter, fire crews, etc.

Operation of the Example Wireless Signal Light System

In an implementation, as shown in FIG. 1, the example wireless transmitter 100 of the wireless signal light system can be powered by a power wire of the battery (e.g., 12 volt battery) of the motorcycle or base vehicle. In an implementation, the wireless transmitter unit 100 is less than ½ inch by ½ inch (<1.27 cm×1.27 cm), and has an internal antenna 108, with a range of more than 1,000 meters. The wireless transmitter unit 100 may have 281,474,976,710,656 addresses, automatically generated by a chip 110, so that the communications between the wireless transmitter 100 and the wireless receiver 200 are unique, and so that no two or more motorcycles, vehicles, trailers, etc., will affect each other's wireless gear/equipment. The example wireless transmitter 100 can easily connect to a motorcycle's existing wiring system (e.g., 5 wires) using one line diagrams relevant to multiple motorcycle manufacturer's wiring charts. In an implementation, the transmitter unit 100 may also be used as a standalone, for example using the chip's gyroscope/accelerometer 106. The wireless transmitter 100 can be implemented on new motorcycles, mopeds, scooters, skateboards, boats, hover boards, jet packs, ATVs, and other personal transportation devices by manufacturers. Then, motorcyclists or vehicle operators only have to obtain the illuminated articles and gear 600 & 700 & 800 & 900 & 1000 & 1100, each having a wireless receiver 200, and pair the illuminated article 600 with their motorcycle via the synch button 214. The wireless transmitter 100 can pair and communicatively couple with numerous illuminated articles 600 & 700 & 800 & 900 & 1000 & 1100 so that a motorcycle rider and even passenger(s) may wear one or multiple illuminated articles 600, gear, and clothing with LED lights of the example system, including but not limited to helmets 600, boots 1100, shoes, backpacks 700, gloves 1000, clothing, vests, jackets 800, race suits 900, trailers 1300, and so forth. The example mobile phone application 300 allows the user to adjust functions of the LEDs on all of the equipment, such as intensities, colors of LEDs, emergency flash parameters, and strobe affects.

In FIG. 2, an example wireless receiver 200 may be less than ½ inch by ½ inch (<1.27 cm×1.27 cm), and may have an internal antenna 208 with a range of more than 1000 meters. The wireless receiver 200 can begin an emergency flash mode (EFM) when separated from the wireless transmitter unit 100, for example by more than 10 feet, or when activated by the gyroscope/accelerometer 106 located on the wireless transmitter 100, when activated by the gyroscope/accelerometer located on the wireless receiver 200, or when activated by the gyroscope/accelerometer located on the user's mobile phone, through the mobile phone application 300.

The wireless receiver 200 has a small ‘synch’ pushbutton 214, which in one implementation, when pressed within 10 seconds of the motorcycle transmitter's 100 start up (e.g., when the ignition switch is turned on), pairs or synchs with a motorcycle equipped with the example wireless transmitter 100. The pairing or synchronization only needs to be performed once, unless pairing or synching with a different motorcycle's wireless transmitter 100.

The wireless receiver 200 controls all of the lights or LEDs on the respective illuminated article 600, which duplicates the operation of signal lights on the motorcycle or base vehicle.

In an implementation, the LEDs of an illuminated article 600 illuminate continuously at half illumination at initial startup of the ignition switch, then perform signaling functions (turn signals, brakes, etc.), but always at a minimum of at least half illumination, only shutting off when the motorcycle is turned off.

In an implementation, the LEDs of the example wireless signal light system are made in custom lengths and may use custom voltages (3 volt) with no associated transistors to drain power from the battery 500, so that the batteries 500 may be much smaller, lighter, and safer, for long periods of time, that systems using 10-14 volts. Most automotive LED systems are 12 volt systems and require a transistor for every 3 LEDs, resulting in higher heat, shorter lamp life, and which require a larger and heavier battery for power. The example LEDs herein are waterproof and shockproof so that upon impact they operate better than conventional unprotected LEDs. The example LEDs herein may be protected by a clear silicon, injected molded lenses, and other types of lenses and covers. The example LEDs are controlled by instances of the example wireless receiver 200.

The example motorcycle helmet 600, as an illuminated article of the system, has recessed, semi-recessed, or surface-mounted LEDs with waterproof sealed lenses within the outer helmet shell, the LEDs similar to the front and rear lighting on a modern day automobile. The helmet has vents 614 in the front that move air to the inside of the helmet, and to the LEDs and rechargeable battery 500 compartments, cooling those areas. Each helmet 600 has a wireless transmitter unit 100, in a watertight compartment within, next to the rechargeable battery compartment 500. The front of the helmet 600 has yellow or orange left and right accessory LEDs 604, which turn on at startup of the motorcycle's ignition switch, which powers up the wireless transmitter 100 of the system. At startup, in one implementation, the yellow or orange LEDs power on at half power or half illumination, or with minimum output & brightness, continuously illuminated and then reflect active left and right turn signaling via maximum output & maximum brightness during signaling of the left or right turn, mirroring the motorcycle's turn signals and accessory lighting system, only turning off when the motorcycle ignition is turned off. The rear of the helmet 600 has yellow or orange left and right accessory LEDs 606, and red tail light LEDs 608 that turn on at the startup of the motorcycle's ignition switch. These rear LEDs of the helmet 600 can operate at half power or half illumination or minimum output and brightness, continuously illuminated, and then reflect the left and right turn signals with maximum output and brightness. The brake signal LEDs 608 also indicate an active braking signal with maximum output and brightness, and turn off when the motorcycle ignition is turned off.

The helmet 600 has a wireless receiver unit 200, with all the wireless functions, as described above, including a USB port 602 for charging the battery 500 and a small, accessible push ‘synch’ button 214, for pairing the helmet with the wireless transmitter 100 on a vehicle. The helmet 600 may have a speaker 612 that when the EFM is activated will send out a loud decibel alarm and may also be used for voice activation. The helmet 600 also may or may not have a headlamp 610, recessed, semi-recessed, or surface mounted on the front of the helmet 600.

In FIG. 7, the example illuminated backpack 700 may have a molded, firm shell 710, that has a waterproof exterior backing that will not deform from wind shear, and is lightweight, for example about 3 lbs. Reflective or illuminated logos 616 and 360 degree piping 708 adds more visibility to the backpack during the day and night. The illuminated backpack 700 may have an organizer panel inside with sleeves and panels for office accessories, including a separate small, padded laptop/iPad/notepad pouch. In addition, the backpack 700 may have a concealed aerodynamic carry handle 712 and ergonomic, padded, fully adjustable shoulder straps 702, with quick release exit buckles 704. The front of the backpack may have a bolstered, padded foam profile that increases air ventilation between the rider and the backpack 700. With water bottle straps on the inside, it is hydration ready, and in a clear sleeve there can be kept an emergency card that is easily accessible for paramedics to find the rider's personal emergency information, in case of an accident. All wires from the signally LEDs are hidden between the back foam shell and the inside red, felt lining, for example. The front of the backpack has yellow or orange left and right accessory LEDs 604, mounted on or within the shoulder straps 702, that turn on at the startup of the motorcycle's ignition switch. At startup, the yellow or orange LEDs power on at half power/half illumination, or with minimum output and brightness, continuously illuminated and reflecting the active left and right turn signaling with maximum output and maximum brightness, mirroring the motorcycle's lighted turn signaling and accessory light systems, and only turning off when the motorcycle ignition is turned off. The rear of the backpack 700 has yellow or orange left and right accessory LEDs 606, and red tail light LEDs 608 that turn on at the startup of the motorcycle's ignition switch at half power/half illumination, or with minimum output and brightness, continuously illuminated and reflecting the left and right turn signaling with maximum output and brightness. The brake signal LEDs 608 also signal braking action with maximum output and brightness, and turn off when the motorcycle ignition is turned off. On the inside of the backpack there may be a separate, small, water tight zippered pouch 802, that holds an instance of the wireless receiver 200, with all the wireless functions described above, including a USB port 602 for charging the battery 500 and a small, accessible ‘synch’ pushbutton 214, for pairing the backpack with a wireless transmitter unit 100 of the system, on a motorcycle or vehicle. The example backpack 700 may have a speaker 612 that when the EFM is activated will send out a loud decibel alarm and may also be used for voice activation.

Our vests, jackets, race suits and clothing have reflective or illuminated logos 616 and 360 degree piping 708 adds more visibility to the vests, jackets, race suits and clothing, during the day and night. All the wires from the LEDs are hidden between the inner and outer garment material or are completely wireless, with the Receiver unit 200 in each of the lenses that house the LEDs. The front of the vest, jacket, race suit, clothing, has YELLOW left and a right accessory LEDs 604, mounted on the front and shoulders, that turn on at the startup of the motorcycle's ignition switch. At startup the yellow LEDs power on at half power/illumination minimum output/brightness, continuously and reflect the left and right turn signals maximum output/brightness, of the motorcycle's lighted turn and accessory light system, only turning off when the motorcycle ignition is turned off. The rear of the vest, jacket, race suit, clothing, has YELLOW left and a right accessory LEDs 606, and RED tail light LEDs 608, that turn on at the startup of the motorcycle's ignition switch, at half power/illumination minimum output/brightness, continuously and reflect the left and right turn signals maximum output/brightness, as well as brake signal 608, maximum output/brightness, and turns off when the motorcycle ignition is turned off. On the lower back, near the waist line, there's a separate, small, water tight zippered pouch 802, that holds an Receiver unit 200, with all the wireless functions, as stated above, including a USB port 602 for charging the battery 500 and a small, accessible push ‘synch’ button 214, for pairing the vest, jacket, race suit, clothing, with a transmitter unit 100 on a vehicle. The vest, jacket, race suit, clothing has a speaker 612 that when the EFM is activated will send out a loud decibel alarm and may also be used for voice activation.

In FIG. 10, the example gloves 1000 may have LEDs mounted on a circuit board within a water proof, wind tight enclosure attached to a wireless receiver unit 200, with a small rechargeable internal battery 500, or the LEDs may be recessed, semi-recessed, or surface-mounted within the gloves 1000 and protected by waterproof silicon, lens, etc., and the battery 500 and wireless receiver unit 200 are remotely located. With left and right gloves 1000, the motorcyclist and passengers are more visible during the day and night from each side of the motorcycle, scooter, moped, ATV, personal transportation device, that conventionally has no lighting in the glove or hand area whatsoever. The gloves 1000 can have yellow or orange left and right turn signal LEDs (depending on left and right glove), and accessory LEDs 604 mounted on the outer side of the gloves 1000 that turn on at the startup of the motorcycle's ignition switch. At startup, the yellow or orange LEDs power on at half power, half illumination, or minimum output and brightness, are continuously illuminated and reflect the left and right turn signaling of the motorcycle or vehicle via maximum output and brightness during a signal, only turning off when the motorcycle ignition is turned off. A separate small watertight zippered pouch 802 may hold an instance of the wireless receiver unit 200, with all the wireless functions described above, including a USB port 602 for charging the battery 500 and a small, accessible ‘synch’ pushbutton 214 for pairing the gloves 1000 with a wireless transmitter 100 on the motorcycle or vehicle. The gloves 1000 has a speaker 612 that when the EFM is activated will send out a loud decibel alarm and may also be used for voice activation.

In FIG. 11, the example boots 1100/shoes may have LEDs mounted on a circuit board within a water proof, wind tight enclosure attached to a wireless receiver unit 200, with a small rechargeable internal battery 500, or the LEDs may be recessed, semi-recessed, or surface-mounted within the boot/shoe 1100 and protected by waterproof silicon, lens, etc., and the battery 500 and wireless receiver unit 200 are remotely located. With left and right boots/shoes 1100, the motorcyclist and passengers are more visible during the day and night from each side of the motorcycle, scooter, moped, ATV, personal transportation device, that conventionally has no lighting in the boot or shoe area whatsoever. The boots/shoes 1100 can have yellow or orange left and right turn signal LEDs (depending on left and right boot/shoe), and accessory LEDs 604 mounted on the outer side of the boot/shoe 1100 that turn on at the startup of the motorcycle's ignition switch. At startup, the yellow or orange LEDs power on at half power, half illumination, or minimum output and brightness, are continuously illuminated and reflect the left and right turn signaling of the motorcycle or vehicle via maximum output and brightness during a signal, only turning off when the motorcycle ignition is turned off. The rear heel of the boot/shoe 1100 has red tail light LEDs 608 that turn on at the startup of the motorcycle's ignition switch at half power, half illumination, or minimum output and brightness, can be continuously illuminated under some conditions, and reflect the braking signals of the motorcycle or vehicle via maximum output and brightness during a signal, turning off when the motorcycle ignition is turned off. A separate small watertight zippered pouch 802 may hold an instance of the wireless receiver unit 200, with all the wireless functions described above, including a USB port 602 for charging the battery 500 and a small, accessible ‘synch’ pushbutton 214 for pairing the boot/shoe 1100 with a wireless transmitter 100 on the motorcycle or vehicle. The boot/shoe 1100 has a speaker 612 that when the EFM is activated will send out a loud decibel alarm and may also be used for voice activation.

An instance of the wireless transmitter 100 can be installed not only in motorcycles, but also in automobiles, semi-trucks, tow trucks and other transportation devices that require lighting and other communications between trailers (boats, semi, hauling, RV, etc.) or other devices. Such applications can eliminate the need for wiring and wiring harnesses between such vehicles when a trailer is equipped with an instance of the example wireless receiver unit 200. An automobile, semi-truck, etc., only needs to connect the hitch and the trailer can automatically reflect the signal lighting system of the automobile, semi-truck, or tow truck (that is, accessory lights, brake lights, turn signals, flashers, lights turning on and off, and so forth).

Also, with the example wireless transmitter 100 installed on automobiles, semi-trucks, etc., communications can be made between motorists and motorcyclists, bicyclists, runners, walkers, hikers, etc., including fire trucks and fire fighters, to make these better aware of other drivers and vehicles in their vicinity, for example by displaying these on the automobile's GPS screen, mobile device, by an alarm, by sound, and/or an indicator on the dashboard or instrument panel.

Example Methods

FIG. 14 shows an example method of automotive signaling from an article worn by a human operator of a vehicle. In the flow diagram, the operations are shown as individual blocks.

At block 1402, an automotive light signal is transmitted from a vehicle via a wireless radio transmission.

At block 1404, the automotive light signal is wirelessly received at an article worn by a human operator of the vehicle.

At block 1406, an automotive signal light on the article worn by the human operator is actuated, based on the automotive light signal sent from the vehicle.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

While the present disclosure has been disclosed with respect to a limited number of embodiments, those skilled in the art, having the benefit of this disclosure, will appreciate numerous modifications and variations possible given the description. It is intended that the appended claims cover such modifications and variations as fall within the true spirit and scope of the disclosure.

1. A system, comprising:
an article associated with a rider of a vehicle;
an automotive signal light on the article;
a receiver associated with the article;
a transmitter associated with the vehicle for wirelessly sending an automotive signal to the receiver; and
a power source for actuating the automotive signal light on the article based on the automotive signal wirelessly sent to the receiver by the transmitter.

2. The system of claim 1, wherein the article is wearable by the rider of the vehicle.

3. The system of claim 1, wherein the article is selected from the group consisting of a helmet, a backpack, a case, a jacket, a vest, a race suit, pants, chaps, boots, shoes, gloves, clothing, a sidecar, and a trailer.

4. The system of claim 1, wherein automotive signal light on the article is selected from the group consisting of an accessory light, a running light, a parking light, a turn signal, a brake light, an emergency flasher, a blinker, and a reverse light.

5. The system of claim 1, wherein the automotive signal light on the article comprises one or more light emitting diodes (LEDs).

6. The system of claim 5, wherein the one or more LEDs operate at a voltage of 3.7 volts or less.

7. The system of claim 1, wherein the vehicle is selected from the group consisting of a motorcycle, a moped, a scooter, a skateboard, a pair of running shoes, skis, a snowmobile, a snowboard, an ATV, a bicycle, a golf cart, roller skates, a hover board, a jetpack, a watercraft, an automobile, a mail truck, an emergency vehicle, a fire truck, a personal transportation device, and a group transportation device.

8. The system of claim 1, wherein the transmitter communicates with the receiver via a Bluetooth or a Wi-Fi wireless connection.

9. The system of claim 1, wherein the transmitter uses a unique wireless address to distinguish communications of the transmitter from communications of other transmitters.

10. The system of claim 9, wherein a pushbutton on the receiver of each article synchronizes communications of the article with communications of the transmitter when the pushbutton is actuated within a time interval after the transmitter turns on.

11. The system of claim 1, wherein the automotive signal light turns on with continuous half-brightness when the vehicle turns on; and
wherein the automotive signal light increases to full-brightness when actuated to signal based on the automotive signal wirelessly sent to the receiver by the transmitter.

12. The system of claim 1, wherein the power source has a protection circuit board (PDB) to prevent battery hazards.

13. The system of claim 1, further comprising an emergency flash circuit activated by a distance separation beyond a threshold between the transmitter and the receiver, or activated by sensing a position of the article via an accelerometer or a gyroscope.

14. The system of claim 13, wherein the emergency flash circuit notifies an emergency contact via a phone of the rider.

15. The system of claim 1, further comprising a mobile device application in communication with the transmitter or the receiver, wherein the mobile device application includes a user interface for setting a parameter, the parameter selected from the group consisting of a LED brightness, a LED light color, a flash characteristic, a LED logo color, a LED flash mode, a flash speed, a duration, an emergency flash parameter, and an emergency contact parameter.

16. The system of claim 1, further including a notification module in the transmitter to wirelessly alert an electronic device of another vehicle of the presence of the vehicle bearing the transmitter.

17. A method, comprising:
transmitting an automotive light signal from a vehicle via a wireless radio transmission;
wirelessly receiving the automotive light signal at an article worn by a human operator of the vehicle; and
actuating an automotive signal light on the article worn by the human operator based on the automotive light signal sent from the vehicle.

18. The method of claim 17, wherein the automotive signal light on the article comprises one of an accessory light, a running light, a parking light, a turn signal, a brake light, an emergency flasher, a blinker, and a reverse light; and
wherein the article is selected from the group consisting of a helmet, a backpack, a jacket, a vest, a race suit, pants, chaps, boots, shoes, gloves, and clothing.

19. The method of claim 17, further comprising signaling a left turn by actuating the automotive signal light on a left glove or a left boot based on the automotive signal light on the left glove or the left boot worn by the human operator based on the automotive light signal sent from the vehicle; and
signaling a right turn by actuating the automotive signal light on a right glove or a right boot based on the automotive signal light on the right glove or the right boot worn by the human operator based on the automotive light signal sent from the vehicle.

20. The method of claim 17, further comprising adjusting a lighting parameter of the automotive signal light on the article worn by the human operator via a user interface of a mobile phone application in communication with the article.
